(19) United States
(12) Patent Application Publication
(10) Pub. No.: US 2003/0044000 A1
(43) Pub. Date: Mar. 6, 2003

(54) Electronic device with rotatable keypad and display

(76) Inventors: Tony N. Kfoury, Lisle, IL (US); Minh H. Duong, Lake Bluff, IL (US); Michael D. Hareng, Lake In The Hills, IL (US); John F. Robin, Westmont, IL (US)

Correspondence Address: Roland K. Bowler II, Motorola, Inc., Intellectual Property Section, 600 North U.S. Highway 45, Libertyville, IL, 60048, US

(21) Appl. No.: 09/941,521

(22) Filed: Aug. 29, 2001

(51) Int. Cl. H04M 1/00; H04M 3/00

(52) U.S. Cl. 379/433.04; 379/368

(57) ABSTRACT

A method and apparatus for orienting the character input area keypad (102) and a display image (110) of an electronic device (100). The orientation of the character input area (102) is sensed relative to a housing (108) of the electronic device (100). The display image (110) on a display (104) of the electronic device (100) has its orientation changed to a predetermined orientation relative to the housing (108) as a function of the orientation of the character input area (102). The housing (108) has a physically rotatable keypad (102) and an electronically rotatable display image (110). A sensor (504) provides a sensor signal representative of the orientation of the keypad (102) relative to the housing (108) of the electronic device (100). Display drivers (508) form the display image (110) on the display (104). A processor (500) receives the sensor signal and in response thereto modifies the display drivers (508) to produce the display image (110) on the display (104) with an orientation relative to the housing (108) that is a function of the orientation of the keypad (102).

### FIELD OF THE INVENTIONS

The present invention relates generally to a communication device or portable electronic device, and more particularly to electronic devices having a rotatable keypads and displays.

### BACKGROUND OF THE INVENTIONS

Electronic devices such as cell phones are well known in the prior art. Recently, cell phones have taken on functions other than just audio communication. For example, cell phones are marketed which have modems that allow the cell phone to interface with the Internet. This allows users to send or receive e-mail.

A typical cell phone and user interface has a speaker, a microphone, a display, and a character input device, such as a keypad. For receiving e-mail, the user initiates a connection with a service provider and downloads his e-mail. This e-mail is then displayed on the display of the cell phone, the display typically having a length greater than its width. Such a cell phone is disclosed, for example, in U.S. Pat. No. 6,000,336.

It is sometimes desirable for the image to be displayed in a landscape view as opposed to a portrait view, for example for reading e-mail. Prior art electronic devices can display information on an electronic screen in one of two different orientations. See, for example, U.S. Pat. No. 5,926,364 and U.S. Pat. No. 6,000,336. If the display of information is changed from a portrait view to a landscape view, however, the keypad of a typical cell phone not oriented properly relative to the information displayed. Also, in either mode, the location of the keypad relative to the display does not always best accommodate both right and left hand users.

### BRIEF DESCRIPTION OF THE DRAWINGS

The various aspects, features and advantages of the present invention will become more fully apparent to those having ordinary skill in the art upon careful consideration of the following Detailed Description of the Invention with the accompanying drawings described below.

FIGS. 1-4 depict a cell phone according to an exemplary embodiment of the present invention in different configurations.

FIG. 5 is a block diagram of the cell phone according to an exemplary embodiment of the invention.

FIG. 6 is an exploded perspective view of a portable device according to an exemplary embodiment of the invention.

FIG. 7 is an exploded view of a rotatable keypad in accordance with an exemplary embodiment of the invention.

FIGS. 8-10 are partial cross-sectional views depicting one example of a keypad assembly in accordance with one embodiment of the invention.

FIG. 11 is an alternative embodiment of a keypad support in accordance with one embodiment of the invention.

FIGS. 12, 13 and 14 are partial cross sectional views of sensors used for detecting the orientation of the keypad in one embodiment of a device of the present invention.

FIG. 15 depicts the position of the keys relative to the key sensors in the keypad according to one embodiment of the present invention.

FIG. 16 depicts an alternative configuration of the keys relative to key sensors (e.g., domes) according to the present invention.

### DETAILED DESCRIPTION OF THE INVENTIONS

The present invention is drawn to methods and apparatuses for orienting a character input area (e.g., a keypad, touch screen etc.) and a display image of an electronic device. The orientation of the character input area is sensed relative to a housing of the electronic device. The display image on a display of the electronic device has its orientation changed to a predetermined orientation relative to the housing as a function of the orientation of the character input area. The housing has a physically rotatable keypad and an electronically rotatable display image. A sensor provides a sensor signal representative of the orientation of the keypad relative to the housing of the electronic device. Display drivers form the display image on the display. The processor receives the sensor signal and in response thereto modifies the display drivers to produce the display image on the display with an orientation relative to the housing that is a function of the orientation of the keypad.

The keypad has a plurality of keys in a key housing and a plurality of key sensors (e.g., domes) that sense activation of the keys. The key sensors are located in a sensor housing that is adjacent to the key housing. The key sensors may be one of resistor sensors, capacitive sensors, and bubble switches. The keypad has at least first and second and possibly third orientations. The second orientation is rotationally substantially ninety degrees counter-clockwise from the first orientation. The third orientation is rotationally substantially ninety degrees clockwise from the first orientation. The keypad can also have a fourth orientation that is rotationally substantially 180 degrees from the first orientation. The electronic device further has at least one lookup table for remapping the keys relative to the key sensors.

The present invention has general applicability, and is useful in any type of electronic device having a movable keypad and an electronically movable display. One embodiment of the present invention is depicted in FIG. 1 and is a cell phone 100. Cell phone 100 has a housing 108 with a keypad 102 and a display screen 104 mounted thereon. In the orientation depicted in FIG. 1 the display 104 has a height, which is greater than its width, which is typical for a standard cell phone. However, in the cell phone 100 the 100 keypad 102 is physically rotatable.

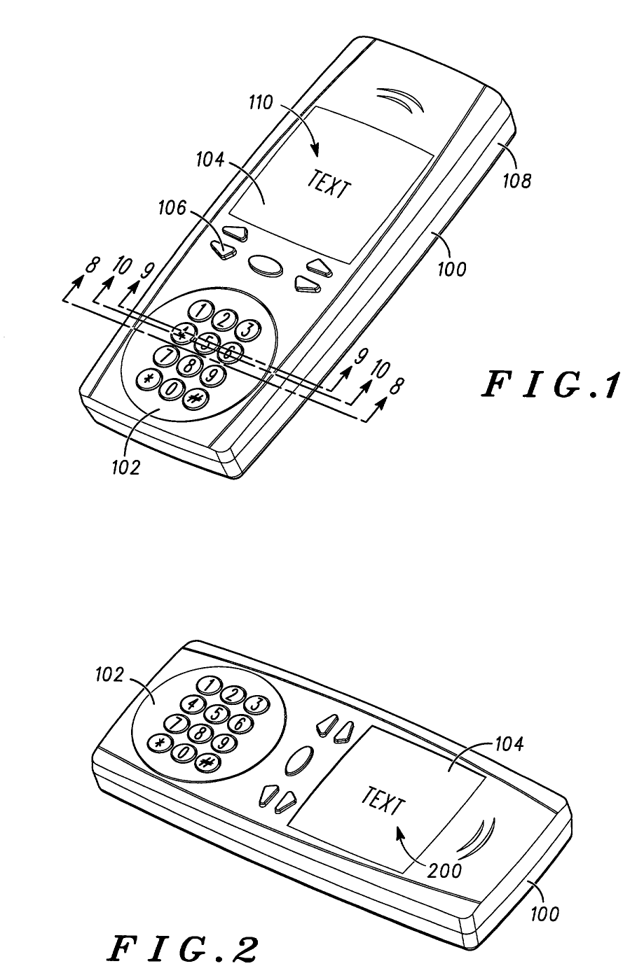

In FIG. 2 the keypad 102 has been rotated 90° counterclockwise to a second orientation as compared to the first orientation in FIG. 1. In response to the rotation of the keypad 102 the text 200 is now displayed in a landscape view on the display 104. In FIG. 1 the text 100 is displayed in a portrait view on the display 104.

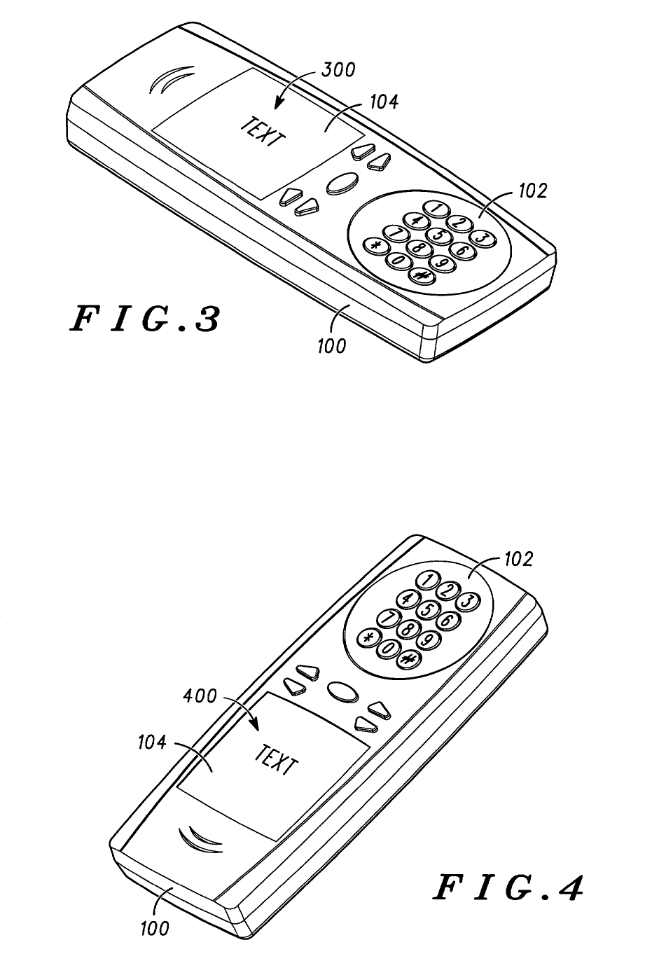

FIG. 3 depicts a third orientation of the cell phone 100 in which the keypad 102 has been rotated substantially 90° clockwise. In this third orientation the keypad 102 is to the right of the display 104. The text 300 is now displayed in a landscape view, which is opposite the landscape view of text 200 in FIG. 2.

FIG. 4 shows a fourth orientation in which the cell phone 100 has the keypad 102 rotated 180° from the keypad position shown in FIG. 1. This results in the display 104 being beneath the keypad 102. In this orientation the text 400 is in a portrait view opposite to that of the portrait view of FIG. 1. It should be understood that other degrees of rotation of keypad 102 are contemplated by the present invention, and other electronically rotatable orientations of the display are also within the present invention.

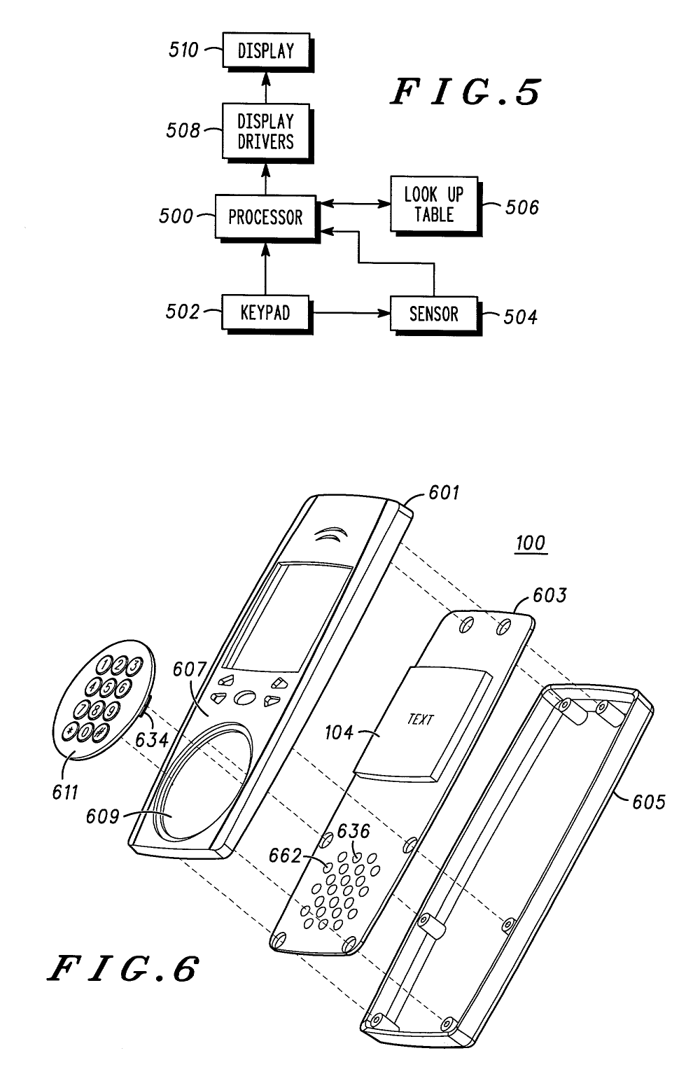

FIG. 5 is a general block diagram depicting the present invention. The processor 500 interfaces with other elements in the cell phone establishing communication, as well as standard elements such as speakers and microphones (not shown). In the context of the present invention the processor 500 receives signals from a keypad 502. A sensor 504 provides a sensor signal to the processor 500, which is representative of the rotational orientation of the keypad 502. The processor 500 uses at least one lookup table 506 for remapping keys relative to key sensors for different orientations of the keypad 502. The processor 500 then uses appropriate display drivers 508 for forming the display image on the display 510. The use of display drivers 508 for rotating images on a display is known in the art.

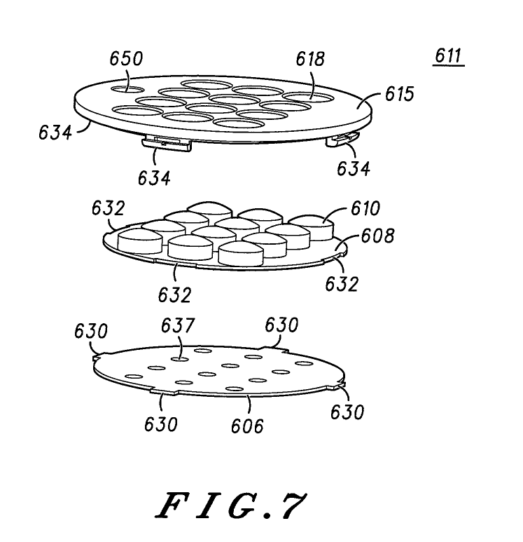

Referring to FIGS. 6 and 7, one example of the cell phone 100 includes a top cover 601, a keypad assembly 611, a printed circuit board 603 and a base 605 or rear cover. The top cover 601 includes a circular rotatable keypad seat 607 formed within a circular opening 609. The keypad assembly 611 includes keypad disk 615, keypad membrane 608, and keypad support 606. A keypad support 606 supports a keypad membrane 608 such as a mylar bubble keypad membrane, which has a plurality of keys 610. A keypad disc 615 includes orifices 618 spaced to receive key 610.

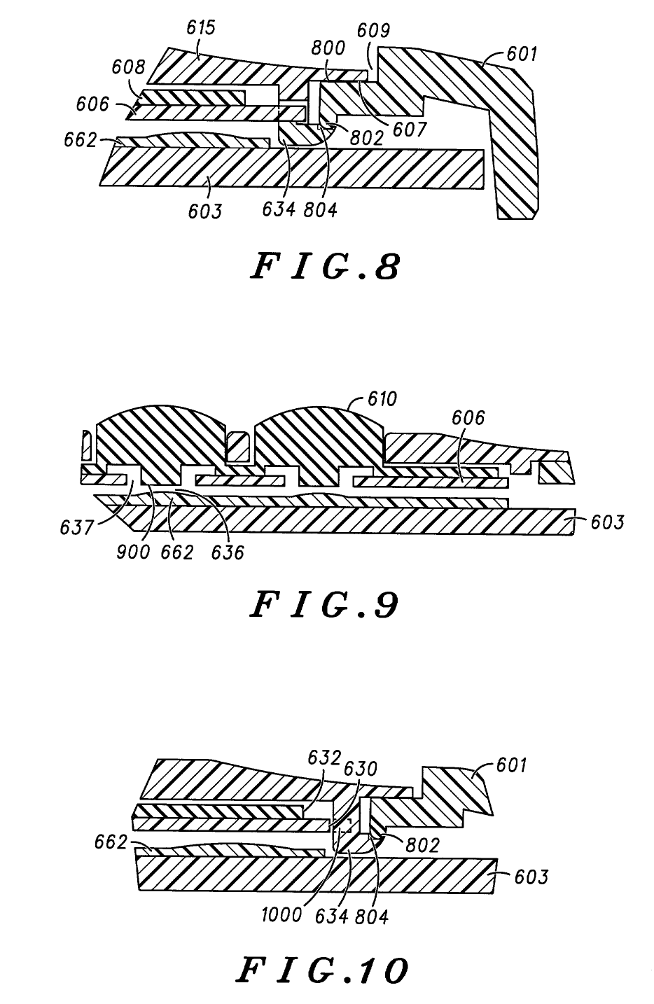

Referring to FIGS. 8 and 9, the base 603 includes a dome sheet array 662 with key sensors 636, suitably aligned to contact a depressed key for effecting operation of the key sensor 636 when the key 610 is depressed. Such dome sheet arrays may be mylar bubble membrane structures as known in the art. It should be understood that other types of key sensors 636 could be utilized, such as resistive or capacitive sensors. These are also well known in the art.

Accordingly, the character input area includes the rotatable keypad assembly having the keypad support 606, the keypad disk 615 and the keypad membrane 608, which is interposed between the keypad support and the keypad disk. The keypad support 606 includes a plurality of projections 630, which in this embodiment protrude from an outer periphery of the keypad support and are spaced equidistant about a circumference of the keypad support 606. In this example, the plurality of projections are spaced approximately 90° from one another. In this example, the plurality of projections are coplanar with the keypad support 606. However, it will be recognized that any suitable configuration may be used.

The keypad membrane 608 includes corresponding notches 632 that correspond to tabs 634 that are integrally molded as part of keypad disk 615. In addition, the keypad support 606 includes orifices 637 corresponding to keypad 610 on the keypad membrane 608 to allow the bottom surface of each of the keys to contact a corresponding dome in the dome sheet array 662.

The keypad disk 615 also may include, if desired, a finger detent 650 to allow a user to place their thumb or other finger into the rotatable disk assembly to more easily rotate the keypad. Accordingly, the keypad disk 615 includes the finger detent 650. It will be recognized, that instead of a detent, a projection surface may be used if desired.

FIGS. 8-10 will be used to describe the tabs 634, rotatable keypad seat 607 and other structures of the keypad assembly 611. As shown in FIG. 8, the circular opening 609 in the front housing of the top cover is defined by surfaces forming the rotatable keypad seat 607. The rotatable keypad seat 607 supports an outer peripheral bottom surface 800 of the keypad disk 615. A bump 802 or protrusion on a bottom surface of the front housing snap fits into a recess 804 in the tab 634. Accordingly, the tab supports the keypad disk 615 and provides orientation positioning for the disk and holds the keypad disk 615 and hence assembly and the front housing and connects to the front housing via the bump 802 and recess 804. The tabs 634 include grooves to receive the front housing.

FIG. 9 illustrates a key 610 having a protrusion 900 that passes through orifice 637 so that when the key is depressed, it contacts a keypad sensor 636 located on the domed sheet array 662.

FIG. 10 illustrates the rotatable keypad assembly with the tab 634 in the keypad disk coupled to the front housing via the bump in recess. In addition, slot 1000 in the tab 634 is shown which is in the back side of the tab to receive the protrusion 630. The notch 632 is also shown which allows the appropriate amount of clearance so that the tab can suitably receive the projection 630.

To detect the keypad orientation, different approaches can be used. For example, a user may press one or two keys in the rotatable keypad assembly (or on a touchscreen) after the keypad has been rotated and the onboard processor then determines, based on the one or two keys, which orientation the keypad is in. A suitable graphic user interface may be presented to the user on the display to tell the user when to depress the one or two keys to suitably initiate the process. In an alternative embodiment, sensing that the orientation of the rotatable keypad may be accomplished by instructing a user via graphic user interface in the display to depress a non-rotatable key, such as a fixed function key such as key 106, for example, a number of times depending upon the current orientation. For example, a user may press key 106 to indicate that the keypad has been rotated by 180° and press another one of the function keys to indicate that it has been rotated by 90°. Alternatively, the same function key may be depressed, for example, a number of times indicating which orientation the rotatable keypad has been placed in. As described below, sensors may be used to generate sensing signals that depict the orientation of the rotatable keypad assembly. Other techniques will be recognized by those having ordinary skill in the art.

According to one embodiment of the present invention, the keypad assembly 611 is physically rotatable in the front housing 601 of the cell phone 100. In an alternative embodiment, a touchscreen may be used instead of a keypad assembly. In this embodiment, the keys are represented as areas on the touchscreen. They are visually rotated in relation to the image orientation on the screen.

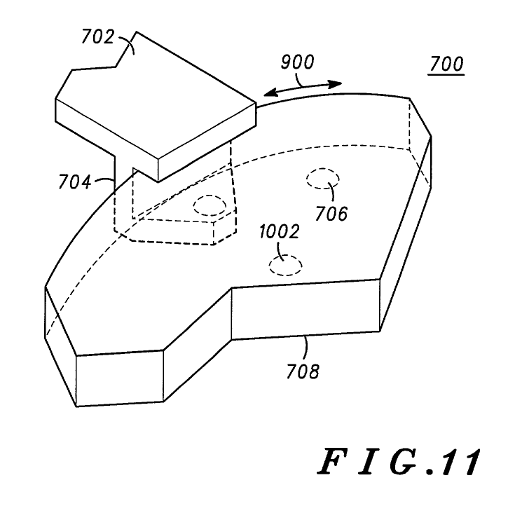

FIG. 11 shows the embodiment for a detent mechanism for keypad 700 in a partial perspective view that indicates rotation in the direction of arrows 900. When keypad 700 is rotated to one of the predetermined orientations, a detent 704 on the housing 702 engages a recess 706 on an underside 708 of the keypad 700 to lock the keypad in place. It is to be understood that numerous other physical structures could be utilized for effecting rotation and engagement of the keypad in the electronic device.

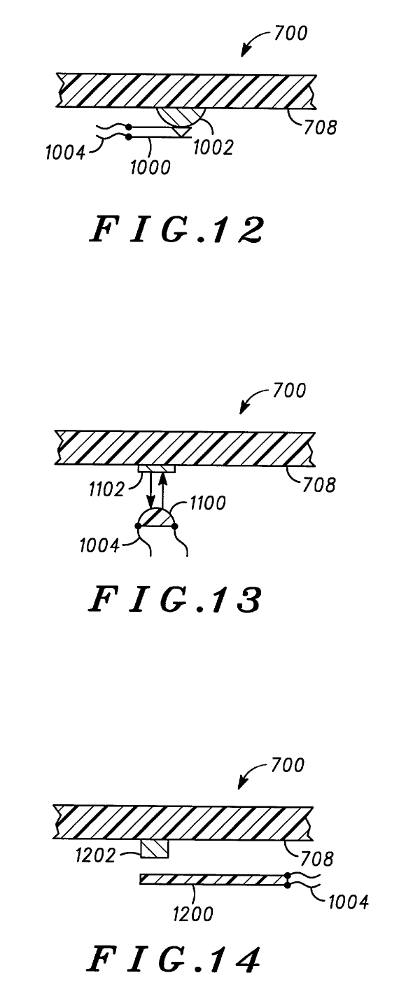

FIG. 12 shows an embodiment for the sensor 1000 that detects the orientation of the keypad 700 with respect to the housing 702. A raised area 1002 is attached to the underside 708 of the keypad 700. Upon rotation to a predetermined orientation the raised area 1002 engages the sensor 1000 (a switch as depicted in FIG. 12) to provide a sensor signal on lines 1004.

FIG. 13 illustrates an alternative sensor 1100, which is a light-emitting diode (LED) and photo diode which senses orientation of the keypad 700 by a metal reflector 1102 which is attached to the underside 708 of keypad 700. FIG. 14 shows another alternative sensor 1200, which is a magnetic read switch that is activated by a magnet 1202 attached to the underside 708 of the keypad 700. As described with reference to FIG. 5, the sensor 504 sends the sensor signal to the processor 500, which then selects the appropriate display drivers 508 for forming the image on the display 510 in a correct orientation with regards to the physical orientation of the keypad 502.

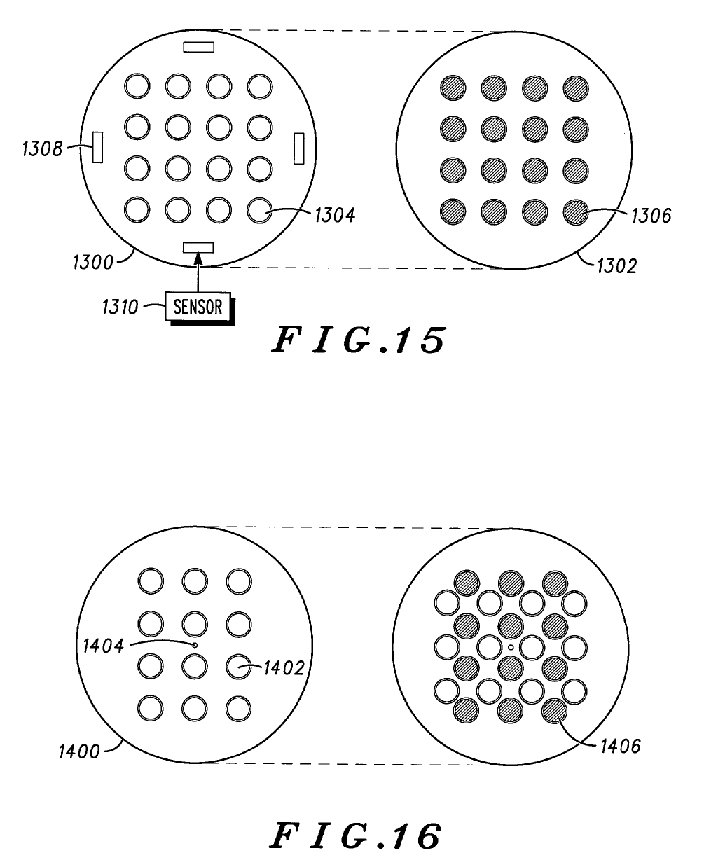

In the electronic device or cell phone 100, depicted in FIGS. 1-4, the keypad can be an assembly wherein the keys and key sensors rotate together. This will require flexible wiring to be provided between keypad and other circuitry in the cell phone. However, a space saving system is shown in FIG. 15 wherein the key housing 1300 rotates relative to a fixed sensor housing 1302. That is, the keys 1304 change position or orientation relative to the key sensors 1306. FIG. 15 also shows sensor elements 1308 which indicate to the sensor 1310 the orientation of the key housing 1300. When the key housing 1300 is rotated 90°, the keys 1304 align with different key sensors 1306. Thus, in operation the processor 500 must remap the key sensors 1306 to the new orientation of the keys 1304. In the present invention this is accomplished by using lookup tables in the element 506 depicted in FIG. 5. The use of lookup tables is well known in the prior art. It is within the scope of the present invention to utilize other known means for assigning the key sensors to the keys of the keypad.

FIG. 16 depicts a keypad housing 1400 having an array of keys 1402, which are three keys wide by four keys long. For rotation of the keypad 1400 about a center point 1404 an array of sensors 1406 must be provided such as depicted in FIG. 16. In this embodiment, two groups of sensors are utilized (depicted by the solid dots for one group and circles for the other group). Key sensor groups are selected and mapped to the keys 1402 dependent upon the rotational orientation of the keypad 1400. Numerous other structures for the keypad 1400 with regards to the keys 1402 and the key sensors 1406 are within the scope of the present invention.

As described above, sensing the orientation of the character input area can be done by any one of: sensing the orientation of the keypad through input from a GUI interface, such as with a touchscreen and a user using a pen or finger to indicate the desired orientation of the character input area, through a dome sheet array, through a fixed key, such as a function key or other non-rotatable key and through a sensor.

In the prior art, if the display is changed from a portrait view to a landscape view and the electronic device or cell phone is turned onto its side, the keypad would then be in a wrong orientation with regards to arrangement of the keys. Furthermore, if the orientation of the cell phone is such that the keypad is to the right of the image, then this would be difficult for a left handed person to use. Furthermore, it is desirable for the image to be displayed in a landscape view as opposed to a portrait view for reading e-mail, for example. However, prior art devices are not sufficiently adaptable to fully meet the present day needs of the users. That is there are numerous disadvantages with current cell phones and other electronic devices in the prior art with regards to portrait and landscape views and orientation of the keypad in relation thereto.

The invention is not limited to the particular details of the apparatus as depicted and other modifications and applications are contemplated. Certain other changes may be made in the above-described apparatus and method without departing from the true spirit and scope of the invention herein involved. It is intended, therefore, that the subject matter in the above depiction shall be interpreted as illustrative and not in a limiting sense.

What is claimed is:

1. A method of orienting a character input area and a display image for an electronic device, comprising:
sensing an orientation of an input area relative to a housing of the electronic device; and
configuring a display image orientation on a display of the electronic device relative to the housing as a function of the orientation of the input area.

2. The method of claim 1, sensing the orientation of the input area includes at least one of sensing the orientation through input from a GUI interface, through a dome sheet array, a fixed key and a sensor.

3. The method according to claim 1, sensing an orientation of an input area by determining the orientation of a physically rotatable input area, configuring the display image orientation by electronically rotating the display image orientation.

4. The method according to claim 1, sensing an orientation of an input area by sensing the orientation of a keypad.

5. The method according to claim 4, remapping keys based on a look-up table relative to key sensors.

6. The method according to claim 1, modifying image forming display drivers in the electronic device in response to sensing the orientation of the input area.

7. A portable electronic device having a housing, comprising:
an input area disposed on the housing;
a display having a display image disposed on the housing;
a sensor for providing a sensor signal representative of an orientation of the input area relative to the housing; and
a display system for changing, in response to the sensor signal, an orientation of the display image on the display relative to the orientation of the input area and as a function of the orientation of the input area.

8. The device of claim 7, the character input area is rotatable; the display image is electronically rotatable.

9. The device of claim 7, the character input area includes a touchscreen and wherein keys are visually rotatable.

10. The device of claim 7, the input area is a keypad.

11. The device of claim 7, the input area includes a rotatable keypad assembly having a keypad support, a keypad disc and a keypad membrane disposed between the keypad support and the keypad disc.

12. The device of claim 11, the keypad support includes a plurality of projections, the keypad membrane includes corresponding notches and the keypad disc includes a plurality of tabs corresponding to the notches and plurality of projections.

13. The device of claim 12, each of the plurality of tabs includes a slot to receive a keypad support projection, and a seat surface rotatably engageable with a surface of a cover of the device.

14. The device of claim 7, the input area has at least first, second and possibly third orientations, the second orientation rotationally substantially 90 degrees counterclockwise from the first orientation, and the third orientation rotationally substantially 90 degrees clockwise from the first orientation.

15. The device of claim 14, the character input area has a fourth orientation rotationally substantially 180 degrees from the first orientation.

16. The device of claim 7, the electronic device further comprises at least one lookup table for remapping the keys relative to the key sensors.

17. The device according to claim 8, the electronic device further comprises display drivers for forming the display image on the display, and a processor for receiving the sensor signal and in response thereto modifying the display drivers in the electronic device for forming the display image on the display as a function of the orientation of the character input area.

18. A portable electronic device, comprising:
a physically rotatable keypad;
a display having a display image;
a sensor for providing a sensor signal representative of an orientation of the keypad relative to the electronic device;
display drivers for forming the display image on the display; and
a processor for receiving the sensor signal and in response thereto modifying the display drivers for forming the display image on the display with an orientation that is a function of the orientation of the keypad.

19. The device of claim 18, the keypad has a plurality of keys held in a key housing, and a plurality of key sensors that sense activation of the keys, the key sensors located on a sensor housing.

20. The device of claim 19, the key sensors are one of resistive sensors, capacitive sensors, and bubble switches.

21. The device of claim 18, the keypad has at least first, second and possibly third orientations, the second orientation rotationally substantially 90 degrees counterclockwise from the first orientation and the third orientation rotationally substantially 90 degrees clockwise from the first orientation.

22. The device of claim 21, the keypad has a fourth orientation rotationally substantially 180 degrees from the first orientation.

23. The device of claim 18, wherein the electronic device further comprises at least one lookup table for remapping the keys relative to the key sensors.

24. A portable electronic device, comprising:
a housing;
a keypad pivotally disposed on the housing, the keypad pivotally positionable between at least first and second positions;
a display disposed on the housing;
the display having a first display configuration when the keypad is in the first position,
the display having a second display configuration when the keypad is in the second position.

25. The device of claim 24, the keypad is pivoted a first angle between the first and second positions, the first display configuration pivoted a second angle relative to the second display configuration, the first angle the same as the second angle.
